(19) United States
(12) Patent Application Publication
(10) Pub. No.: US 2009/0293284 A1
(43) Pub. Date: Dec. 3, 2009

(54) CUTTING TOOL WITH MULTIPLE SCISSORS TOOLS

(76) Inventors: Lisa A. Avery, Tinley Park, IL (US); Miriam N. Smith, Chicago, IL (US)

Correspondence Address: BRINKS HOFER GILSON & LIONE, P.O. BOX 10395, CHICAGO, IL, 60610, US

(21) Appl. No.: 12/474,018

(22) Filed: May 28, 2009

Related U.S. Application Data
(60) Provisional application No. 61/130,368, filed on May 30, 2008.

(51) Int. Cl. B26B 3/06

(52) U.S. Cl. 30/152; 30/155; 30/159

(57) ABSTRACT

A cutting tool having a body, a first scissors tool coupled with the body and having a first pair of blades cooperating to define a first cutting pattern, and a second scissors tool coupled with the body and having a second pair of blades cooperating to define a second cutting pattern.

### CROSS-REFERENCE TO RELATED APPLICATION

This patent application claims the benefit under 35 U.S.C. § 119(e) of U.S. provisional patent application Ser. No. 61/130,368, filed May 30, 2008 and entitled CUTTING TOOL WITH MULTIPLE SCISSORS TOOLS, the entire contents of which is incorporated herein by reference.

### BACKGROUND OF THE INVENTION

1. Field of the Invention

The invention relates generally to a cutting tool having multiple cutting attachments. More specifically, the invention relates to a cutting tool having a body and first and second scissors tools coupled with the body, where each of the first and second scissors tools has a pair of blades defining a cutting pattern.

2. Related Technology

Scissors tools are known in the art for cutting objects such as paper. Scissors tools typically include straight blades for cutting objects in a straight pattern. However, more complex or decorative patterns may be desirable, particularly for applications such as scrapbooking applications, gift wrapping applications, and other arts and crafts applications. For some applications or projects, a user may wish to include several different patterns and therefore may wish to use several different scissors tools. However, utilizing several different scissors tools may be cumbersome, and the user may have difficulty organizing, storing, transporting, or finding such different scissors tools.

It is therefore desirous to provide a cutting tool that permits a user to easily and quickly attain and create different cutting patterns.

### BRIEF SUMMARY OF THE INVENTION

In one aspect of the present invention, a cutting tool is provided having a body and first and second scissors tools coupled with the body. The first scissors tool includes a first pair of blades cooperating to define a first cutting pattern and the second scissors tool includes a second pair of blades cooperating to define a second cutting pattern.

In one aspect, each of the first and second scissors tools is pivotally coupled with the body so as to define a stored position and an operational position. The body defines a periphery and the first and second scissors tools are positioned substantially completely within the periphery of the body when in the stored position.

In another aspect, each of the first and second scissors tools includes a protrusion that extends beyond the periphery of the body when the first and second scissors tools are in the stored position such that a user is able to grip the protrusion and move the scissors tools from the stored position to the operational position.

In yet another aspect, the first and second scissors tools each include a first arm pivotally coupled with the body and a second arm pivotally connected to the first arm so as to define an open position and a closed position of the scissors tool. Each of the first and second scissors tools includes a spring urging the first and second arms into the open position. The first and second arms are in the closed position when the scissors tools are in the stored position and are urged towards the open position when the scissors tools are in the operational position.

In another aspect, the first cutting pattern is a pinking pattern and the second cutting pattern is a straight pattern.

In yet another aspect, the cutting tool includes third, fourth, fifth, and sixth scissors tools each coupled with the body and having third, fourth, fifth, and sixth pairs of blades cooperating to define third, fourth, fifth, and sixth cutting patterns, respectively. The third, fourth, fifth, and sixth cutting patterns may include a square wave pattern, a wave pattern, a scallop pattern, a pillows pattern, or any other suitable cutting pattern.

Further objects, features, and advantages of the present invention will become apparent from consideration of the following description and the appended claims when taken in connection with the accompanying drawings.

### BRIEF DESCRIPTION OF THE DRAWINGS

FIG. 1 is a perspective view of a cutting tool embodying the principles of the present invention;

FIG. 2 is a top view of the cutting tool shown in FIG. 1, showing first, second, and third scissors tools;

FIG. 3 is a first side view of the cutting tool shown in FIG. 1;

FIG. 4 is a bottom view of the cutting tool shown in FIG. 1, showing fourth, fifth, and sixth scissors tools;

FIG. 5 is a second side view of the cutting tool shown in FIG. 1;

FIG. 6 is a first end view of the cutting tool shown in FIG. 1;

FIG. 7 is a second end view of the cutting tool shown in FIG. 1;

FIG. 8 is a perspective view of the cutting tool shown in FIG. 1, where the first scissors tool, which defines a pinking cutting pattern, is shown in an operational position and the remaining scissors tools are shown in a stored position;

FIG. 9 is a perspective view of the cutting tool shown in FIG. 1, where the second scissors tool, which defines a straight cutting pattern, is shown in the operational position and the remaining scissors tools are shown in the stored position;

FIG. 10 is a perspective view of the cutting tool shown in FIG. 1, where the third scissors tool, which defines a square wave cutting pattern, is shown in the operational position and the remaining scissors tools are shown in the stored position;

FIG. 11 is a perspective view of the cutting tool shown in FIG. 1, where the fourth scissors tool, which defines a wave cutting pattern, is shown in the operational position and the remaining scissors tools are shown in the stored position;

FIG. 12 is a perspective view of the cutting tool shown in FIG. 1, where the fifth scissors tool, which defines a scallop cutting pattern, is shown in the operational position and the remaining scissors tools are shown in the stored position;

FIG. 13 is a perspective view of the cutting tool shown in FIG. 1, where the sixth scissors tool, which defines a pillows cutting pattern, is shown in the operational position and the remaining scissors tools are shown in the stored position;

FIG. 14 is a side view of a second embodiment of a cutting tool embodying the principles of the present invention;

FIG. 15 is a side view of a third embodiment of a cutting tool embodying the principles of the present invention;

FIG. 16 is a perspective view of a fourth embodiment of a cutting tool embodying the principles of the present invention, where a third scissors tool, which defines a square wave cutting pattern, is shown in the operational position and the remaining scissors tools are shown in a stored position; and

FIG. 17 depicts cutting blades defining varying cutting patterns and embodying principles of the present invention.

### DETAILED DESCRIPTION OF THE INVENTION

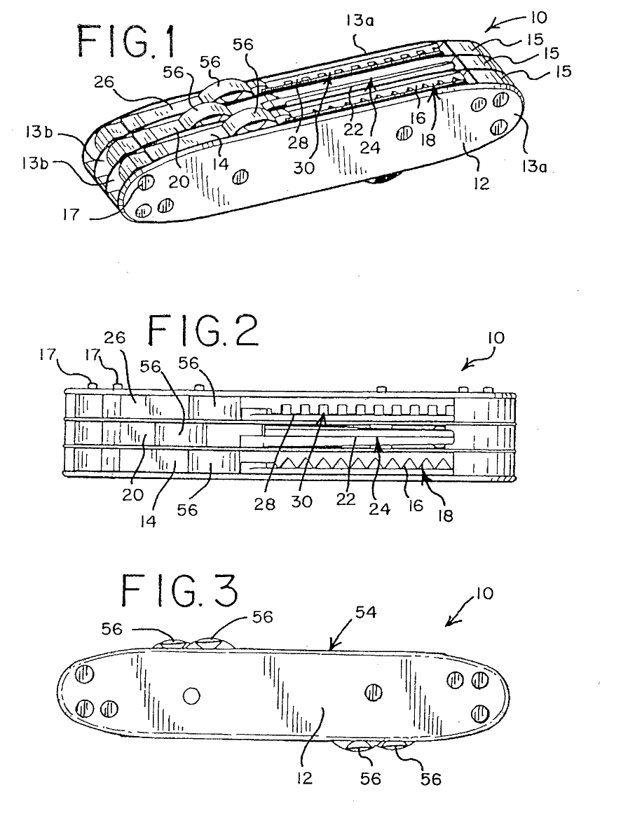

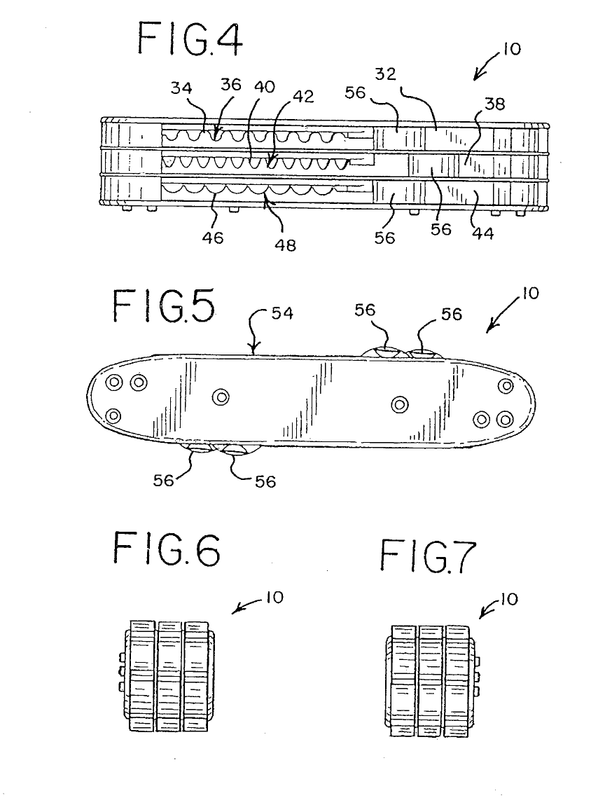

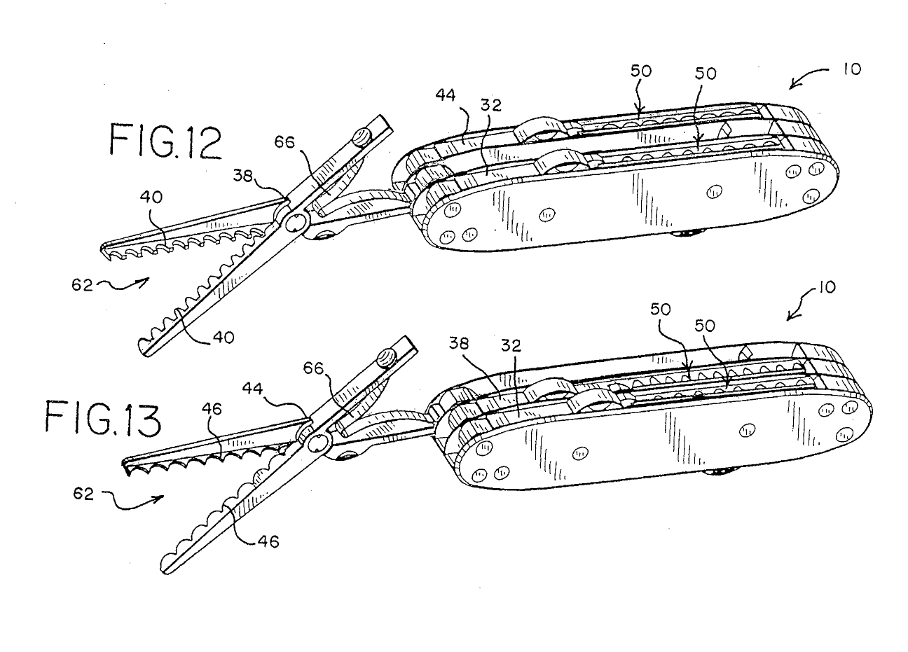

Referring now to the present invention, each of FIGS. 1-16 shows a different view of a cutting tool 10 in accordance with the principles of the present invention. The cutting tool 10 includes a body 12 and a plurality of scissors tools, each of which is pivotally coupled with the body 12 and defines a different cutting pattern. For example, the cutting tool 10 shown in the Figures includes: a first scissors tool 14 having a first set of blades 16 defining a pinking cutting pattern 18; a second scissors tool 20 having a second set of blades 22 defining a straight cutting pattern 24; a third scissors tool 26 having a third set of blades 28 defining a square wave cutting pattern 30; a fourth scissors tool 32 having a fourth set of blades 34 defining a wave cutting pattern 36; a fifth scissors tool 38 having a fifth set of blades 40 defining a scallop cutting pattern 42; and a sixth scissors tool 44 having a sixth set of blades 46 defining a pillows cutting pattern 48.

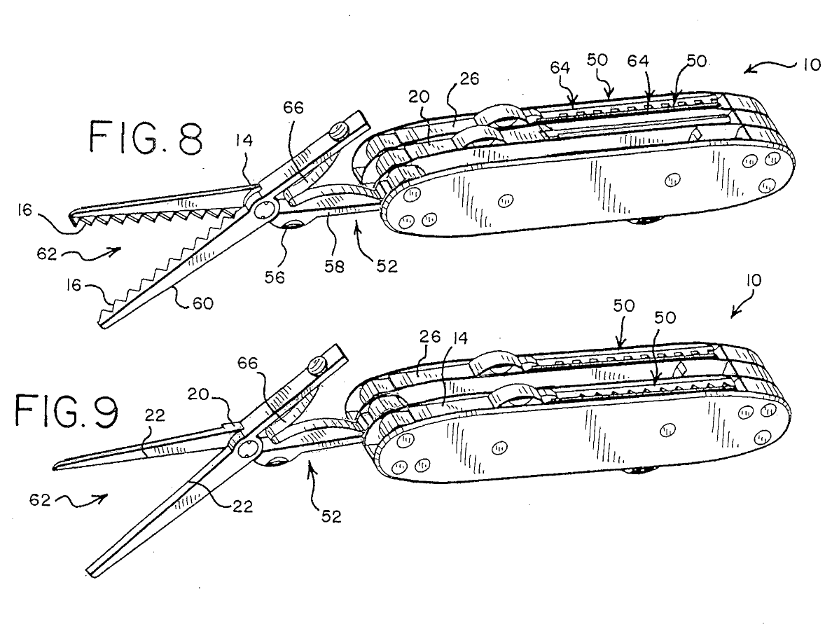

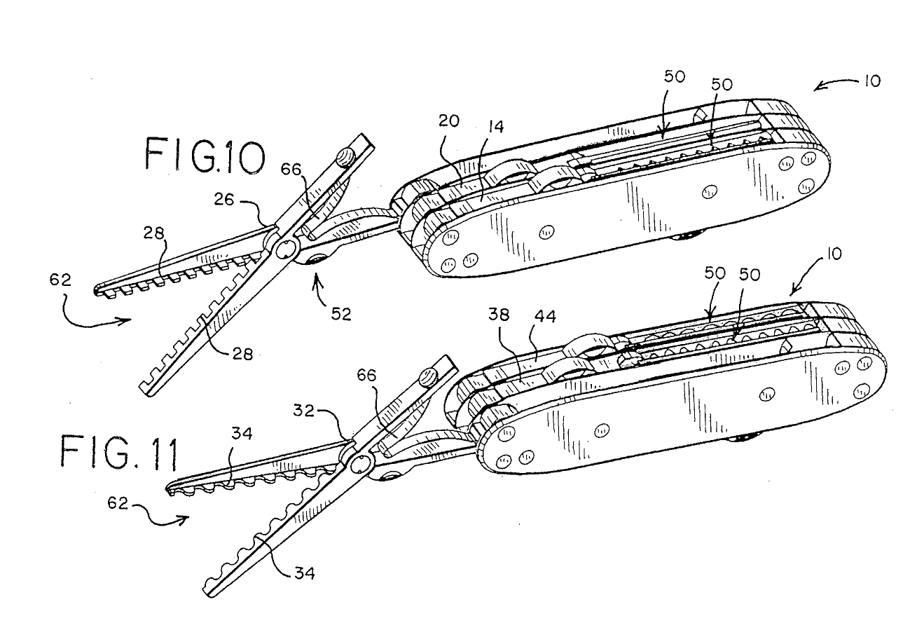

The body 12 includes two side panels 13a and two divider panels 13b positioned between the side panels 13a. The side panels 13a and divider panels 13b are spaced apart from each other by spacers 15. The side panels, divider panels 13b, and scissors tools 14, 20, 26, 32, 38, 44 are coupled together by fasteners such as pins 17. More specifically, the pins 17 extend through a base portion of each of the scissors tools 14, 20, 26, 32, 38, 44 so that the scissors tools 14, 20, 26, 32, 38, 44 are able to pivotally move with respect to the body 12 between a stored position 50 (FIGS. 8-13) and an operational position 52 (FIGS. 8-13). Each of the spacers 15 preferably has a thickness approximately equal to or larger than the thickness of the scissors tools 14, 20, 26, 32, 38, 44 so that the scissors tools 14, 20, 26, 32, 38, 44 are able to pivotally without being obstructed by the side panels 13a or the divider panels 13b. In addition to the pins 17 pivotally coupling the scissors tools 14, 20, 26, 32, 38, 44 to the body 12, the body 12 also includes additional pins 17 that secure together the components of the body 12.

As mentioned above and as best shown in FIGS. 8-13, the scissors tools 14, 20, 26, 32, 38, 44 are pivotally movable between the stored position 50 and the operational position 52. The side panels 13a define a periphery 54 of the body 12. When the scissors tools 14, 20, 26, 32, 38, 44 are in the stored position 50 they are positioned substantially completely within the periphery 54 of the body 12 such that the cutting tool 10 is relatively compact and/or easy to carry or store. However, the scissors tools 14, 20, 26, 32, 38, 44 each include a protrusion 56 that extends beyond the periphery 54 of the body 12 when the scissors tools 14, 20, 26, 32, 38, 44 are in the stored position 50 so that a user is able to grip the protrusion 54 and move the scissors tools 14, 20, 26, 32, 38, 44 from the stored position 50 to the operational position 52. When the scissors tools 14, 20, 26, 32, 38, 44 are in the operational position 52 they are positioned substantially outside of the periphery 54 of the body 12 so that they can be used for cutting or shearing, as is discussed in more detail below. The protrusions 56 shown in the Figures include an indentation to improve the grip thereof. Alternatively, the protrusions 56 may include openings or other features that improve the grip of the protrusions 56.

The scissors tools 14, 20, 26, 32, 38, 44 each include a first pivot arm 58 that is pivotally coupled with the body 12 via the pins 17 and a second arm 60 that is pivotally connected to the first arm 58 so as to define the sets of blades 16, 22, 28, 34, 46. Because the first and second arms 58, 60 are pivotally coupled with each other, they define an open position 62 (FIGS. 8-13) where the two pivot arms are spaced apart from each other and a closed position 64 (FIGS. 8-13) where the two pivot arms engage each other substantially completely along their lengths. During cutting or shearing, the object to be cut (such as paper) is inserted between the arms 58, 60 when they are in the open position 62. The object is then cut when the arms 58, 60 are moved into the closed position 64. The object is cut with a pattern corresponding to the cutting pattern 18, 24, 30, 36, 42, 48 of the sets of blades 16, 22, 28, 34, 46.

The scissors tools 14, 20, 26, 32, 38, 44 also each include a spring 66 urging the arms 58, 60 into the open position 62. Thus, the scissors arms 58, 60 are urged towards the open position 62 when the scissors tools 14, 20, 26, 32, 38, 44 are in the operational position 52. Although the arms 58, 60 are shown in the open position 62 in the Figures when the scissors tools 14, 20, 26, 32, 38, 44 are in the operational position 52, they are able to move between the open and closed positions 62, 64 while the scissors tools 14, 20, 26, 32, 38, 44 are in the operational position 52. Conversely, when the scissors tools 14, 20, 26, 32, 38, 44 are in the stored position 50, the arms 58, 60 are urged into the closed position 64

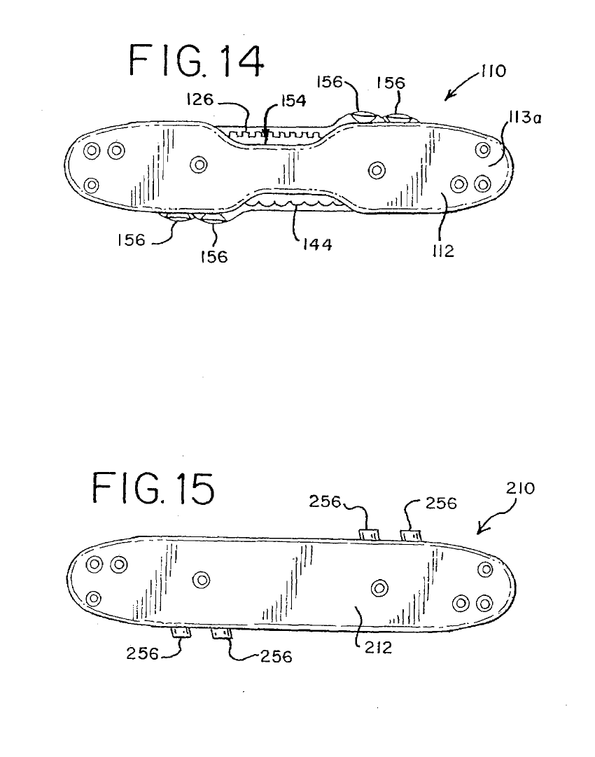

Turning now to FIG. 14, a second embodiment of a cutting tool 110 embodying principles of the present invention is shown. The cutting tool 110 includes a body 112 and a plurality of scissors tools, each of which is pivotally coupled with the body 112 and defines a different cutting pattern. The body 112 includes two side panels 113a and two divider panels positioned between the side panels 113a. The side panels 113a and divider panels are spaced apart from each other by spacers. The side panels 113a define curved portions 154 to improve the gripability of the cutting tool 110. For example, the curved portions 154 shown in FIG. 14 each have a shape such as to conform to a user's hand, fingers, or thumbs. The curved portions 154 also to provide access to the cutting tools, such as the third scissors tool 126 and the sixth scissors tool 144 shown in FIG. 14, so that they user is able to more easily open the cutting tools into an operational position.

Turning now to FIG. 15, a third embodiment of a cutting tool 210 embodying principles of the present invention is shown. The cutting tool 210 includes a body 212 and a plurality of scissors tools, each of which is pivotally coupled with the body 212 and defines a different cutting pattern. The body 212 also includes a plurality of push buttons 256 that are each coupled with one of the various scissors tools. For example, the push buttons 256 are each coupled with a latching mechanism that holds one of the scissors tools in the stored position (as shown in FIG. 15). When one of the push buttons 256 is depressed, the latching mechanism releases one of the scissors tools and the scissors tool is able to move into the operational position. The scissors tools each may be spring-loaded such that they are biased towards the operational position and are able to open automatically when the corresponding push button 256 is depressed.

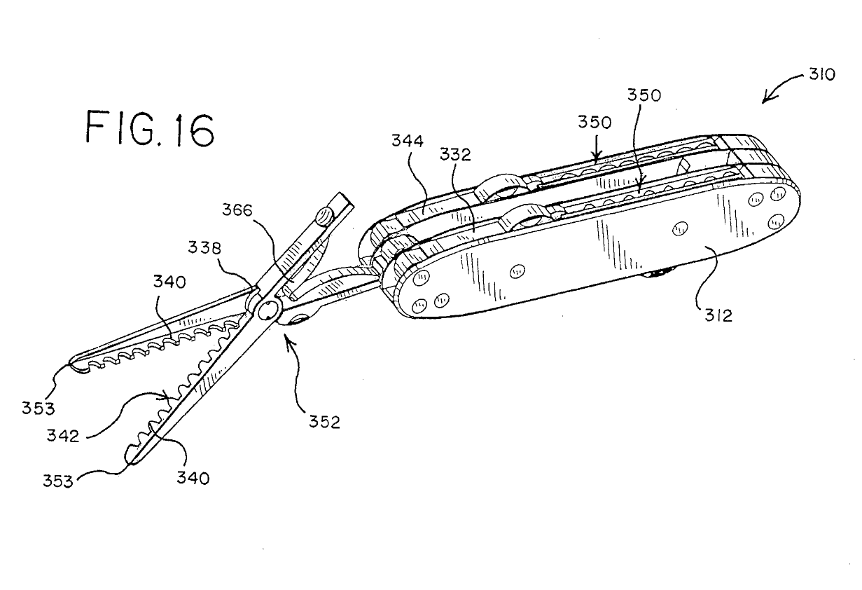

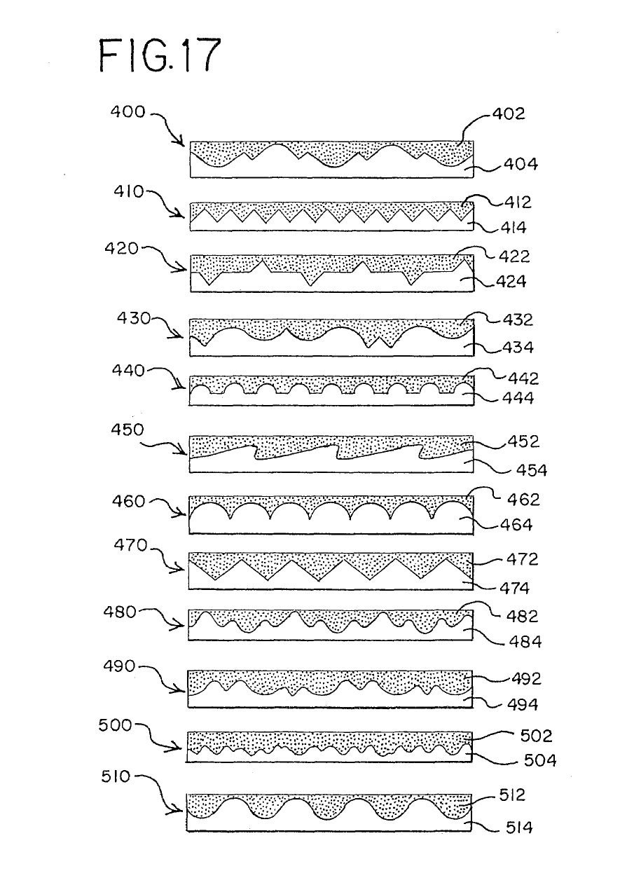

Turning now to FIG. 16, a fourth embodiment of a cutting tool 310 embodying principles of the present invention is shown. The cutting tool 310 includes a body 312 and a plurality of scissors tools, each of which is pivotally coupled with the body 312 and defines a different cutting pattern. The scissors tools 332, 338, 344 are able to move between the stored position 350 and the operational position 352. The scissors tools 332, 338, 344 each include a set of blades define a cutting pattern, such as the fifth set of blades 340 defining a scallop cutting pattern 342. The scissors tools 332, 338, 344 also each include a spring 366 urging the arms into the open position. Each of the sets of blades, such as the fifth set of blades 340, includes a rounded tip 353 to potentially reduce the risk of puncturing a work surface or a user with the tips of the blades.

Alternative embodiments of the cutting tool may include a varying number of scissors tools, such as fewer or more than the six scissors tools shown in the Figures. Additionally, alternative embodiments of the cutting tool may include scissors tools with blades that define cutting patterns other than those shown in the Figures. For example, FIG. 17 depicts cutting blades defining varying cutting patterns and embodying principles of the present invention. Cutting blade 400 includes a first cutting blade (shaded for illustrative purposes) 402 and a second cutting blade 404 that cooperate to define a seventh cutting pattern. Cutting blade 410 includes a first cutting blade (shaded for illustrative purposes) 412 and a second cutting blade 414 that cooperate to define an eighth cutting pattern. Cutting blade 420 includes a first cutting blade (shaded for illustrative purposes) 422 and a second cutting blade 424 that cooperate to define a ninth cutting pattern. Cutting blade 430 includes a first cutting blade (shaded for illustrative purposes) 432 and a second cutting blade 434 that cooperate to define a tenth cutting pattern. Cutting blade 440 includes a first cutting blade (shaded for illustrative purposes) 442 and a second cutting blade 444 that cooperate to define an eleventh cutting pattern. Cutting blade 450 includes a first cutting blade (shaded for illustrative purposes) 452 and a second cutting blade 454 that cooperate to define a twelfth cutting pattern. Cutting blade 460 includes a first cutting blade (shaded for illustrative purposes) 462 and a second cutting blade 464 that cooperate to define a thirteenth cutting pattern. Cutting blade 470 includes a first cutting blade (shaded for illustrative purposes) 472 and a second cutting blade 474 that cooperate to define a fourteenth cutting pattern. Cutting blade 480 includes a first cutting blade (shaded for illustrative purposes) 482 and a second cutting blade 484 that cooperate to define a fifteenth cutting pattern. Cutting blade 490 includes a first cutting blade (shaded for illustrative purposes) 492 and a second cutting blade 494 that cooperate to define a sixteenth cutting pattern. Cutting blade 500 includes a first cutting blade (shaded for illustrative purposes) 502 and a second cutting blade 504 that cooperate to define a seventeenth cutting pattern. Cutting blade 510 includes a first cutting blade (shaded for illustrative purposes) 512 and a second cutting blade 514 that cooperate to define an eighteenth cutting pattern.

While the present invention has been described in terms of preferred embodiments, it will be understood, of course, that the invention is not limited thereto since modifications may be made to those skilled in the art, particularly in light of the foregoing teachings.

What is claimed is:

1. A cutting tool comprising:
a body;
a first scissors tool coupled with the body and having a first pair of blades cooperating to define a first cutting pattern; and
a second scissors tool coupled with the body and having a second pair of blades cooperating to define a second cutting pattern.

2. A cutting tool as in claim 1, wherein each of the first and second scissors tools is pivotally coupled with the body so as to define a stored position and an operational position.

3. A cutting tool as in claim 2, wherein the body defines a periphery and the first and second scissors tools are positioned substantially completely within the periphery of the body when in the stored position.

4. A cutting tool as in claim 3, wherein the each of the first and second scissors tools includes a protrusion that extends beyond the periphery of the body when the first and second scissors tools are in the stored position such that a user is able to grip the protrusion.

5. A cutting tool as in claim 2, wherein each of the first and second scissors tools includes a first arm pivotally coupled with the body and a second arm pivotally connected to the first arm so as to define an open position and a closed position of the scissors tool.

6. A cutting tool as in claim 5, wherein each of the first and second scissors tools includes a spring urging the first and second arms into the open position.

7. A cutting tool as in claim 2, further comprising a third scissors tool coupled with the body and having a third pair of blades cooperating to define a third cutting pattern.

8. A cutting tool as in claim 7, wherein the first cutting pattern is a pinking pattern, the second cutting pattern is a straight pattern, and the third cutting pattern is a square wave pattern.

9. A cutting tool as in claim 7, further comprising:
a fourth scissors tool coupled with the body and having a fourth pair of blades cooperating to define a fourth cutting pattern;
a fifth scissors tool coupled with the body and having a fifth pair of blades cooperating to define a fifth cutting pattern; and
a sixth scissors tool coupled with the body and having a sixth pair of blades cooperating to define a sixth cutting pattern.

10. A cutting tool as in claim 9, wherein the fourth cutting pattern is a wave pattern, the fifth cutting pattern is a scallop pattern, and the sixth cutting pattern is a pillows pattern.

11. A cutting tool as in claim 9, wherein the body defines a periphery and the first, second, third, fourth, fifth, and sixth scissors tools are positioned substantially completely within the periphery of the body when in the stored position.

12. A cutting tool as in claim 11, wherein the each of the first, second, third, fourth, fifth, and sixth scissors tools includes a protrusion that extends beyond the periphery of the body when the first, second, third, fourth, fifth, and sixth scissors tools are in the stored position such that a user is able to grip the protrusion.

13. A cutting tool as in claim 12, wherein each of the first, second, third, fourth, fifth, and sixth scissors tools includes a first arm pivotally coupled with the body and a second arm pivotally connected to the first arm so as to define an open position and a closed position.

14. A cutting tool as in claim 13, wherein each of the first, second, third, fourth, fifth, and sixth scissors tools includes a spring urging the first and second arms into the open position.

15. A cutting tool comprising:
a body;
a first scissors tool pivotally coupled with the body so as to define a stored position and an operational position, wherein the first scissors tool defines a first cutting pattern; and
a second scissors tool pivotally coupled with the body so as to define a stored position and an operational position, wherein the second scissors tool defines a second cutting pattern.

16. A cutting tool as in claim 15, further comprising:
a first release mechanism configured to move between a securing position, where the first scissors tool is secured in the stored position, and a release position, where the first scissors tool is not secured in the stored position; and
a second release mechanism configured to move between a securing position, where the second scissors tool is secured in the stored position, and a release position, where the second scissors tool is not secured in the stored position.

17. A cutting tool as in claim 16, wherein the first and second release mechanisms are push buttons configured to secure the first and second scissors tools, respectively, in the stored position.
